(19) United States
(12) Patent Application Publication
(10) Pub. No.: US 2020/0269822 A1
(43) Pub. Date: Aug. 27, 2020

(54) TRAILER AIRBRAKE AUGMENTATION MECHANISM FOR UNMANNED CONTAINER YARD OPERATIONS

(71) Applicant: Phantom Auto Inc., Mountain View, CA (US)

(72) Inventors: Shay Magzimof, Palo Alto, CA (US); David Clyde, Providence, UT (US); Brett Rogers, West Point, UT (US); David Parunakian, Moscow (RU)

(21) Appl. No.: 16/796,925

(22) Filed: Feb. 20, 2020

Related U.S. Application Data
(60) Provisional application No. 62/809,172, filed on Feb. 22, 2019.
(60) Provisional application No. 62/962,152, filed on Jan. 16, 2020.

(51) Int. Cl. B60T 7/20; B60T 7/16; B60T 8/17; B60T 8/34

(52) U.S. Cl. CPC B60T 7/20; B60T 8/342; B60T 8/1708; B60T 7/16

(57) ABSTRACT

An air brake controller system for a vehicle trailer associated with a vehicle enables an air brake system of the trailer to be controlled via teleoperation control signals when the vehicle is teleoperated. The air brake controller system comprises a wireless communication device to wirelessly receive brake control signals from the vehicle or directly from a remote teleoperation system. An on-board computer of the air brake controller system processes the brake control signals to generate one or more valve control signals that controls flow of air from a compressed air reservoir into air lines connected to the air brake system of the trailer.

### CROSS-REFERENCE TO RELATED APPLICATIONS

This application claims the benefit of U.S. Provisional Application No. 62/809,172 filed on Feb. 22, 2019 and U.S. Provisional Application No. 62/962,152 filed on Jan. 16, 2020, which are each incorporated by reference herein.

### BACKGROUND

### Technical Field

The disclosed embodiments relate generally to the field of remote teleoperation and more specifically to augmentation of cargo trailer air brake systems to enable their support of unmanned container yard truck operations.

### Description of the Related Art

The ongoing explosive growth of computing, geolocation and communication technologies has already enabled productivity improvements across multiple industries and continues to radically transform all facets of modern economies. One of the prominent industries best positioned for enjoying these new developments is the transport container logistics industry. Standardization of cargo handling procedures promoted by the introduction of a unified intermodal transport container infrastructure for sea and land carriers in the mid-20th century has led to a dramatic reduction of transportation costs and has significantly contributed to emergence of the modern globalized economy.

In the United States, most of container shipments entering the country by ocean-faring vessels are processed in container yards, stored temporarily and loaded on trailers or semi-trailers which are then attached to tractor units and hauled to their destinations; similarly, domestic consignors often export their freight by ordering their transportation to a container yard using a trailer truck with subsequent processing and loading of the container on a freight ship. These procedures have seen growing levels of automation designed to keep human agents away from hazardous areas and to reduce costs.

The problem of further automating cargo container handling can benefit from improvements such as enabling container semi-trailers to be transported and handled by unmanned (i.e. fully autonomous or teleoperated) container yard trucks and allowing road trucks operated by human agents to reduce the time spent in the container yard down to the level necessary to detach a trailer with an inbound container or to attach a trailer with an outbound container, while eliminating their participation in any operations restricted to the territory of the container yard. Such level of automation faces several challenges.

One such obstacle is that semi-trailers are equipped with air brakes, which remain engaged and prevent the trailer from moving unless air pressure is applied. This is not an issue with manned operations as the driver of a yard truck can manually connect an airline from the vehicle to the trailer, allowing control over the trailer's brakes. As container yard operations are gradually automated, the process of connecting the airline to a pressure source becomes a barrier that is currently not being solved in a reliable and cost-effective way. This obstacle is especially important in North American markets, as in Europe swap body technique is commonly used for freight container loading and unloading.

As an example of consequences of outdated workflows, container yard operations struggle with misplaced trailers. As carrier trucks bring trailers into the yard they are usually assigned a parking space to leave the trailer. Due to a multitude of reasons those trailers are not always left in the correct space. This causes issues as they are needed for unloading and reloading. It becomes costly to locate misplaced trailers and requires more human agents to be present in the yard, which increases costs and safety risks.

### SUMMARY OF THE EMBODIMENTS

To solve the above described problems, a device enables an unmanned container yard truck to control trailer air brakes when the vehicle is teleoperated. In an embodiment, an air brake controller system includes a wireless communication device that wirelessly receive brake control signals, either from a connected vehicle or from a remote teleoperation system. An on-board computer of the air brake controller system processes the brake control signals to generate one or more valve control signals. A compressed air reservoir for storing compressed air, and a valve controls flow of air from the compressed air reservoir to one or more air lines in response to the valve control signals.

In an embodiment, the one or more air lines comprises a first air brake connector to connect to a service line of the vehicle trailer, a first flexible hose coupled between the valve and the first air brake connector, and a first pressure transducer to sense a first pressure of the first flexible hose and to communicate the first pressure to the on-board computer. Furthermore, the one or more air lines comprises a second air brake connector to connect to an emergency line of the vehicle trailer, a second flexible hose coupled between the valve and the second air brake connector, and a second pressure transducer to sense a second pressure of the first flexible hose and to communicate the second pressure to the on-board computer.

### BRIEF DESCRIPTION OF THE DRAWINGS

For a more complete understanding of the invention, reference is made to the following description and accompanying drawings, in which:

FIG. 1 is a diagram of functional areas of a container yard;

FIG. 2 is a functional flowchart of the system and its interfaces;

FIG. 3 illustrates the components of the system;

FIG. 4 illustrates a plurality of mount embodiments for the system;

FIG. 5 is a flowchart of operating the system in conjunction with an autonomous or a teleoperated yard truck.

### DETAILED DESCRIPTION

### Overview

An air brake controller system for a vehicle trailer associated with a vehicle enables an air brake system of the trailer to be controlled via teleoperation control signals when the vehicle is teleoperated. The air brake controller system comprises a wireless communication device to wirelessly receive brake control signals from the vehicle or directly from a remote teleoperation system. An on-board computer of the air brake controller system processes the brake control signals to generate one or more valve control signals that controls flow of air from a compressed air reservoir into air lines connected to the air brake system of the trailer. Thus, the air brake controller system may pressurize or depressurize air lines to engage or disengage the trailer parking brakes based in part on the teleoperation control signals.

In an embodiment, the system partially comprises magnetic, adhesive or mechanical mounts to facilitate its quick and reliable deployment on the surface of a trailer and its subsequent removal. Such mounts may be fully automated and rely on external signals, possess dedicated controls for manual operation by human agents, or both. Furthermore, the system may comprise a geolocation or positioning unit, and may issue trailer position updates to the container yard asset tracking system or another relevant information systems in substantial real time.

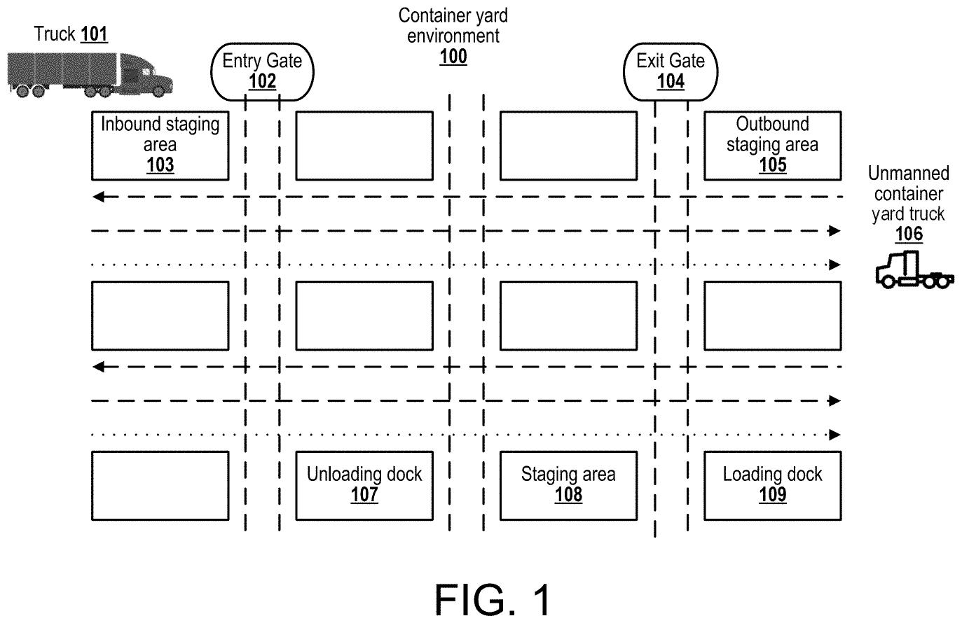

FIG. 1 illustrates a layout and operation of a container yard 100. In an example operation, a carrier truck 101 comprising a tractor unit and a trailer enters the container yard 100 via an entry gate 102, deposits the trailer in a designated lot in the inbound staging area 103, and leaves the container yard 100 via an exit gate 104. Alternatively, a carrier truck 101 comprising a tractor unit enters the container yard 100 via an entry gate 102, picks up a trailer from the designated lot in the outbound staging area 105, and leaves the container yard 100 via an exit gate 104. Alternatively, a carrier truck 101 may both deposit a first trailer and pick up a second trailer in the duration of one cycle.

Typically, a yard truck 106 picks up a deposited trailer from the designated lot in an inbound staging area 103, and transports it to an unloading dock 107. After cargo unloading is complete, a yard truck 106 picks up the trailer and transports it to an empty staging lot 108. After new cargo is ready for loading, a yard truck 106 picks up the trailer and transports it to a loading dock 109. After the new cargo loading is complete, a yard truck 106 picks up the trailer and transports it to an outbound staging lot 110.

Alternatively, a container yard 100 may possess a different layout and other example operations may be performed. For example, the entry and exit gates 102, 104 may be the same physical access point, or a carrier truck 101 comprising a tractor unit may pick up a trailer from the loading dock 109 or deposit a trailer in the unloading dock 107.

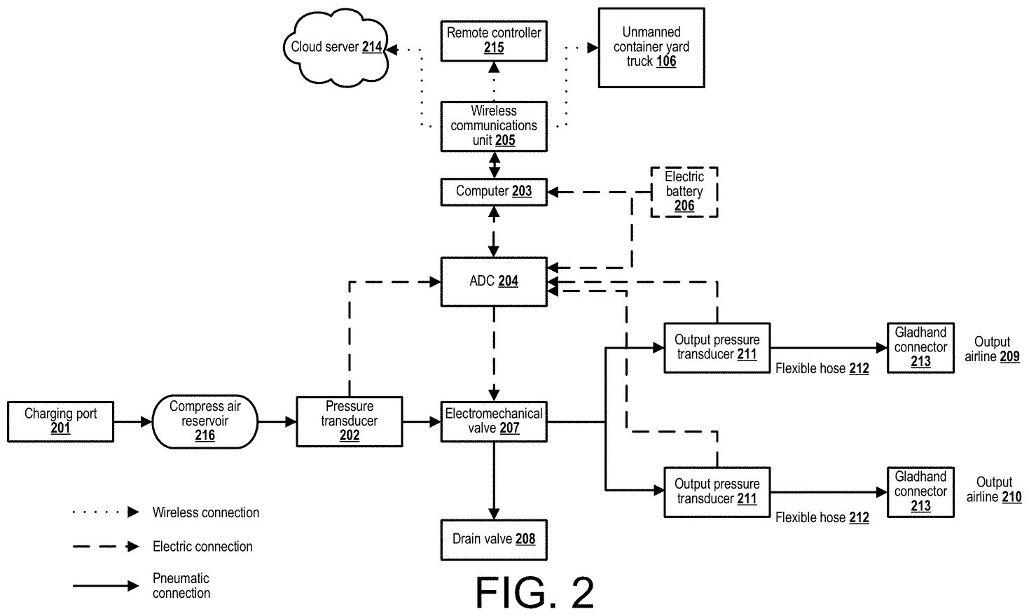

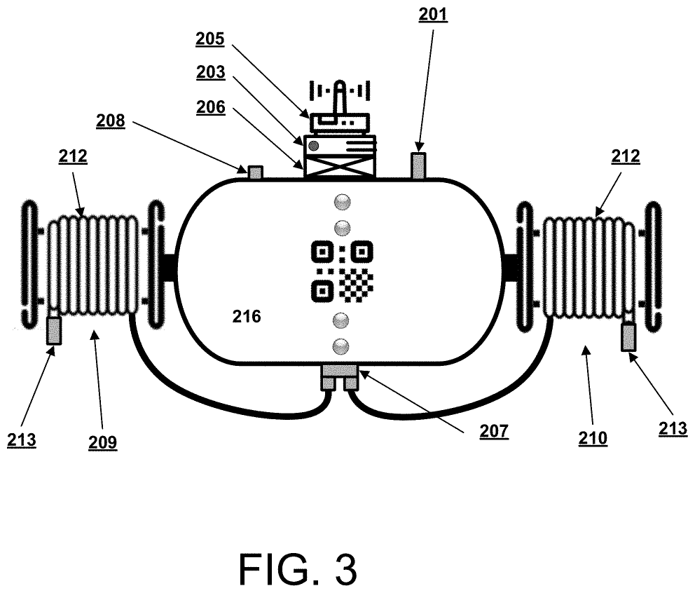

FIG. 2 is a block diagram illustrating an example embodiment of an air brake system 200 for automated container yard operations. FIG. 3 is a diagram illustrating an example structure of the airbrake system 200. FIGS. 2-3 will be described together for convenience.

The air brake system 200 comprises a compressed air reservoir (further referenced to as “tank”) 216 coupled to industry-standard ports (including a charging port 201), a pressure transducer 202 (not visible in FIG. 3) to measure pressure in the tank 216 and provide the measured pressure to the computer 203 via the ADC 204, a low-power industrial computer 203 coupled to an analog to digital converter (ADC) 204 (not visible in FIG. 3) and a wireless communication unit 205 such as a cellular LTE modem, an electric battery 206 or a plurality thereof, an electromechanical valve 207 controlled by the computer 203, a drain valve 208, a first output airline 209 that may be connected to the service line of a truck brake system (also commonly referred to as a control line), and a second output airline 210 that may be connected to the emergency line of the truck brake system. (also commonly referred to as a supply line). The output airlines 209, 210 each comprise an output pressure transducer 211 that senses pressure in the respective airline 209, 210, a sufficiently long flexible hose 212 and a gladhand connector 213. The computer 203 measures the pressure level in different parts of the system 200 based on sensor data from the output pressure transducers 211. The computer 203 also exchanges telemetry and commands with cloud servers 214, remote controllers (represented by either human teleoperators or machine intelligence agents) 215 and with unmanned container yard trucks (further referenced to as “trucks”) 106. For example, the computer may process brake control signals to generate one or more valve control signals for controlling the electromechanical valve 207 in a manner that controls the pressure in the output airline 209, 210. These brake control signals may be received from a truck 106 paired with the system 200 or directly from a remote controller 215 or cloud server 214. The computer 203 may comprise one or more processors and a non-transitory computer-readable storage medium storing instructions executable by the one or more processor to carry out the functions attributed to the computer 203 described herein.

In an embodiment, the computer 203 shares wireless network capacity with the truck 106 to improve network connection reliability responsive to a request from the remote controller 215, the truck 106 associated with the system 200, or responsive to the attachment of a truck 106 to the trailer connected to the system 200.

In an embodiment, the system 200 additionally comprises a plurality of hose storage reels and provides basic hose management capabilities. In a further embodiment, a hose storage reel comprises a retractable spring mechanism capable of applying a recoil force proportional to or exceeding the total weight of the currently extended hose length of the flexible hose 212 and the gladhand connector 213, and supports automatic collection of an unattached hose and simplification of its placement back into the reel. For example, the recoil force may be given by: F(x)≈μ(xλ+m_{gh})·g+δF(x), where x is the length of the currently extended hose 212, m_{gh} is the mass of the gladhand connector 213, A is the linear mass density of the hose 212, g is the gravitational acceleration constant at the surface of the Earth, μ is the friction coefficient of the container yard 100 surface and δF(x) is a positive excess force function.

In an embodiment, the system 200 additionally comprises visual signaling devices such as a light-emitting diode (LED) stripe or a plurality thereof. Such devices may be in turn comprise units combining multiple LED types in one package and allowing individual power control of each LED type and allow to generate color coded signals. Responsive to an issue being detected by the computer 203, the system 200 may provide visual signals to in situ human agents.

In an embodiment, the system 200 additionally comprises a super-twisted nematic display, an electronic ink display, a matrix display or an array of segment indicators. Responsive to an issue being detected by the computer 203, the system 200 may convey detailed information on the issue to in situ human agents.

In an embodiment, the system 200 additionally comprises a piezoelectric speaker or a plurality thereof, and may convey auditory signals to in situ human agents.

In a further embodiment, the system 200 additionally comprises a powered digital speaker or a plurality thereof, and may instruct in situ human agents using text-to-speech technology or prerecorded audio file playback.

In an embodiment, the system 200 additionally comprises a voltmeter implement connected to the ADC 204. Responsive to measurements of the voltmeter, the computer 203 monitors the charge remaining in the electrical battery 206, and performs the appropriate actions such as operating visual signaling devices or transmitting emergency telemetry packets for the subsequent consumption by a remote controller 215.

To facilitate repeated use of the system 200 it is desirable to provide it with electrical battery 206 recharge capabilities in addition to recharge capabilities of the air tank 216 provided via the charging port 201.

In an embodiment, the system 200 additionally comprises externally accessible contacts or ports connected to the battery 206 and optional removable waterproof caps. Such ports may be connected to an external charging device using crocodile clips or other connectors.

In an embodiment, the system 200 additionally comprises a serviceable battery compartment for fast replacement of the battery 206. An in situ human agent may remove a first depleted battery 206 from the compartment, and place a second charged battery 206 into the compartment. Such a compartment may be designed to use thumb screws or similar implements in order to allow a human agent to extract and insert a battery 206 without any additional tools.

The system 200 enables disengagement of trailer air brakes by applying and maintaining the appropriate pressure in the pneumatic system of the trailer, creating a braking system which applies automatically and immediately upon breakaway of a trailer or container from the towing vehicle. To that end, the system 200 maintains pressure in the trailer air brakes when two conditions are simultaneously satisfied in received brake control signals: presence of a positive NO-STOP signal received at the computer 203 from an associated truck 106 and absence of a negative E-STOP signal (e.g., an emergency brake packet) emitted by an associated truck 106.

In an embodiment, the onboard computer 203 records the timestamp of each NO-STOP and E-STOP packet received from the associated truck 106 in a dedicated variable in random access memory and optionally commits it for recording to permanent storage such as a solid state drive or transmits it via wireless network for processing at a remote server 214. Alternatively, the computer 203 may store the timestamps of only n≥1 most recent NO-STOP packets and m≥1 most recent E-STOP packets; for example, such data organization may be provided by two ring buffer data structures. The computer 203 further executes a dedicated program for analysis of the data structures; this program will be referred to as the “daemon”. In a further embodiment, the daemon is scheduled to synchronously access and analyze the contents of a data structure with a certain periodicity or according to a schedule. Such a schedule may be defined by a human agent in advance, or generated by the computer 203. Alternatively, the daemon may be run in an asynchronous fashion, and be invoked by the computer 203 responsive to arrival of a new packet from the associated truck 106 or another relevant event.

In a further embodiment, the daemon running on the computer 203 executes an analysis routine is to verify whether the most recent NO-STOP timestamp in a first data structure exceeds the current timestamp minus a threshold value:

A_{NS}(rbₜₛ)=if(max(rbₜₛ)>T_{current}−Δt_{threshold})?OK:STOP

Here rbₜₛ is a timestamp ring buffer, max(rbₜₛ) is the maximum timestamp value stored therein, T_{current} is the current timestamp as reported by a system clock, and t_{threshold} is the maximum time interval allowed for the system to operate normally past receiving the latest NO-STOP signal. For example, the compute 203 may generate a valve control signal to cause the valve 207 to release pressure in the emergency air line to cause the brake to engage responsive to the timestamp of the last NO-STOP packet being at least a threshold time beyond the last recorded timestamp. The computer 203 may store a predefined threshold value in permanent storage, or update it dynamically depending on extra information available such as the current truck 106 speed or container cargo manifest.

In a further embodiment, the daemon running on the computer 203 executes an analysis routine to verify whether a second data structure contains n≥n_{threshold} values: A_{ES}(rbₜₛ)=if (len(rbₜₛ)>n_{threshold})? STOP: OK.

wheere len(rbₜₛ) is the current element count thereof, and n_{threshold} is the maximum number of E-STOP packets allowed for the system to operate normally. E-STOP packet timestamps may be marked for automatic expiration upon a desired time interval so that E-STOP packets that are obsolete and no longer relevant to the current environment do not affect the decision-making process.

In one example, a conservative routine would trigger emergency braking as soon as a single E-STOP packet has been recorded (n_{threshold}=0) by releasing pressure in the emergency air line.

In a further embodiment, responsive to either of the analysis routines executed by the daemon returning the STOP result, the computer 203 issues a command to the electromechanical valve 207 or drain valve 208 to release the pressure in the pneumatic braking system of the trailer either instantly in order to perform emergency braking or according to a predefined procedure in order to perform a controlled slowdown and to avoid possible vehicle stability problems.

In a further embodiment, the computer 203 records the timestamp of the state change of the trailer's pneumatic braking system from DISENGAGED to EMERGENCY-ENGAGED in random access memory, local permanent storage or using network resources, and ignores any and all air brake disengagement commands received during a predetermined time interval after the last emergency airbake engagement.

In a further embodiment, responsive to an engagement of trailer brakes due to the loss of NO-STOP signal, due to a fault in the pneumatic system (detected, for example, as an unmitigated loss of pressure in the airlines by the pressure transducers 202, 211) or other similar conditions, the computer 203 may attempt to alert the remote controller 215 to the issue via the wireless communications unit 205 connected to, for example, directly to the associated truck 106, to a remote server 214, or via V2V or V2I communications infrastructure. This information may be displayed as an element on the heads-up display (HUD) of a human teleoperator agent, or be used in the utility function of the machine intelligence agent operating the truck 106.

In another embodiment, the onboard computer 203 supports PARTBRAKE packet type. Such a packet may contain additional information such as target pressure in the pneumatic braking system of the trailer or the percentage of maximum braking effort. Responsive to receiving a PARTBRAKE packet, the daemon may establish the required pressure level to a practical degree of accuracy, or perform progressive braking using the valves 207, 208 and pressure transducers 202, 211.

In another embodiment, the system 200 partially comprises a bus or a wireless interface linking the computer 203 with smart load sensing relays installed on a trailer's axles or suspension units. The system 200 may adjust the required braking effort responsive to data on the weight of the container and its presence received from the load sensing relays. For example, such an approach may be used to match truck and trailer deceleration, and to prevent jack-knifing or swinging instabilities.

In another embodiment, the system 200 partially comprises a humidity sensor linked to the onboard computer 203. Responsive to information received from the sensor, the computer 203 may alert in situ personnel, the associated truck 106 or a remote controller 215 that the moisture level in the pneumatic system is dangerously high and that the air tank 216 requires to be fully drained before further operation. For example, such an approach may be used to prevent formation of ice in the pneumatic system in colder climates.

For safety purposes is necessary for the onboard computer 206 to be aware of whether trailer airlines are attached to the gladhand connectors 213.

In an embodiment, the output airlines 209, 210 may additionally comprise internal light meters connected to the onboard computer 203 directly or via the ADC 204. A daemon process running on the onboard computer 203 may record, transmit and analyze the readings of each light meter on a regular schedule or responsive to receiving commands from the associated truck 106 or the remote controller 215. For example, the daemon may interpret consistent zero or near zero level measurements by a light meter over a desired time interval Δtₗᵤₓ as evidence that an airline 209, 210 associated with the lux meter has been attached to a trailer: A_{c}=if (max_{Δt}_{ₗᵤₓ}(Lₗᵤₓ₋ᵢ)≤L_{threshold})? CON:DISCON.

In another embodiment, the output airlines 209, 210 may additionally comprise external light meters connected to the onboard computer 203 directly or via the ADC 204. A daemon process running on the onboard computer 203 may record, transmit and analyze the readings of each light meter on a regular schedule or responsive to receiving commands from the associated truck 106 or the remote controller 215. For example, the daemon may use a comparison of readings obtained from an internal and an external light meter in order to reduce the potential rate of false positives in a dark environment: A_{c}=if (max(Lₗᵤₓ₋ᵢ)≤L_{threshold} && (min(Lₗᵤₓ₋ₑ)−max(Lₗᵤₓ₋ᵢ)≥ΔL))? CON:DISCON

In another embodiment, a gladhand connector 213 partially comprises one or more light-emitting devices and one or more light meters linked to the computer 203 directly or via the ADC 204. In the case of a single light-emitting device and a single light meter they may be placed in a manner that would permit the light meter to register emissions of the light-emitting device whenever an output airline 209, 210 is free, but would cause the emissions to be blocked by an attached opposing gladhand connector. Similar arrangements for multiple light-emitting devices and light meters may be envisaged. A daemon process running on the onboard computer 203 may record, transmit and analyze the readings of each light meter on a regular schedule or responsive to receiving commands from the associated truck 106 or the remote controller 215.

In a further embodiment, the light-emitting device and the light meter are chosen to support signaling in the infrared range or a specific wavelength. This may be useful in scenarios where additional light sources are not desirable.

In a further embodiment, the light-emitting device may modulate its signal in a manner unique to each emitter-sensor pair in order to avoid crosstalk between different pairs, including those mounted on different but spatially adjacent gladhand connectors.

In another embodiment, output airlines 209, 210 may additionally comprise an internal sonar or an infrared ranging device linked to the onboard computer 203 directly or via the ADC 204. A daemon process running on the onboard computer 203 may record, transmit and analyze the readings of these ranging devices on a regular schedule or responsive to receiving commands from the associated truck 106 or the remote controller 215. For example, the daemon may use the the time profile of ranging device results, return signal delay spectra or other information to determine whether an airline 209, 210 associated with the ranging device has been attached to the trailer.

In another embodiment, gladhand connectors 213 on the output airlines 209, 210 may additionally comprise one or more pressure sensors linked to the onboard computer 203 directly or via the ADC 204. When the gladhand connectors 213 are mated correctly, a substantial amount of force is applied between the trailer and tank connectors. A daemon process running on the onboard computer 203 may record, transmit and analyze the readings of these pressure sensors on a regular schedule or responsive to receiving commands from the associated truck 106 or the remote controller 215. For example, consistent high pressure readings of all sensors installed on one gladhand connector 213 may be interpreted by the daemon as evidence that an output airline 209, 210 is firmly attached to a trailer's pneumatic system.

In another embodiment, gladhand connectors 213 on the output airlines 209, 210 may partially comprise one or more four-point ohmmeters linked to the onboard computer 203 directly or via the ADC 204. If a specific gladhand connector 213 model utilizes a firm metal-to-metal contact in case of a properly established connection, the ohmmeters may be used to measure and track the total conductivity of the glad hand connector terminal. A daemon process running on the onboard computer 203 may record, transmit and analyze the readings of these ohmmeters on a regular schedule or responsive to receiving commands from the associated truck 106 or the remote controller 215. For example, a rapid change in gladhand terminal conductivity may be interpreted by the daemon as additional evidence that a specific output airline is attached to a trailer's pneumatic system.

In a further embodiment, the system 200 may additionally comprise a variable oscillator, and use gladhand connector possessing an additional conductive coil as a part of its circuit to maintain a high-frequency, low-current signal. Measurements of signal characteristics may then be used to determine the electrical characteristics of the glad hand and to determine physical factors currently affecting it, including the presence of an opposing gladhand connector in the circuit.

In a further embodiment, the output airlines 209, 210 may additionally comprise one or more contact (reed) switches linked to the onboard computer 203 directly or via the ADC 204, and placed in a manner that would cause the circuit to close when a magnetic opposing gladhand connector of a trailer airline is located in the proximity of the output airline gladhand connector. A daemon process running on the onboard computer 203 may record, transmit and analyze the readings of these ohmmeters on a regular schedule or responsive to receiving commands from the associated truck 106 or the remote controller 215.

In a further embodiment, responsive to the readings airline 209, 210 connection status the computer 203 may provide visual and auditory cues to in situ human agents using embodiments such as those previously described, transmit information to networked servers 214, the remote controller 215 or the associated truck 106 via the wireless communications unit 205. For example, responsive to receiving this information the associated truck 106 may alert the remote controller 215 via designated programmatic interfaces or other channels, or the computer 203 may attract the attention of an in situ human agent such as the driver of the inbound truck delivering the trailer that is being attached to the system 200 that the operations involving manual intervention are not yet concluded and that the system 200 should be connected to the trailer's airlines.

In an embodiment, the system 200 may additionally comprise a positioning unit, for example a global navigation satellite system (such as a GPS or GLONASS) receiver, vehicle-to-vehicle and vehicle-to-infrastructure based localization devices, a camera or ranging based SLAM unit, an inertial measurement unit, or any combination of the above. The computer 203 may transmit readings received from the positioning unit to unmanned trucks 106 present in the container yard 100, remote servers 214 or other recipients. For example, this information may be used to eliminate the necessity to assign trailers to specific lots and to locate misplaced trailers, as well as to provide real-time updates to the container yard 100 information system to enable estimation of trailer arrival time to staging areas or hubs.

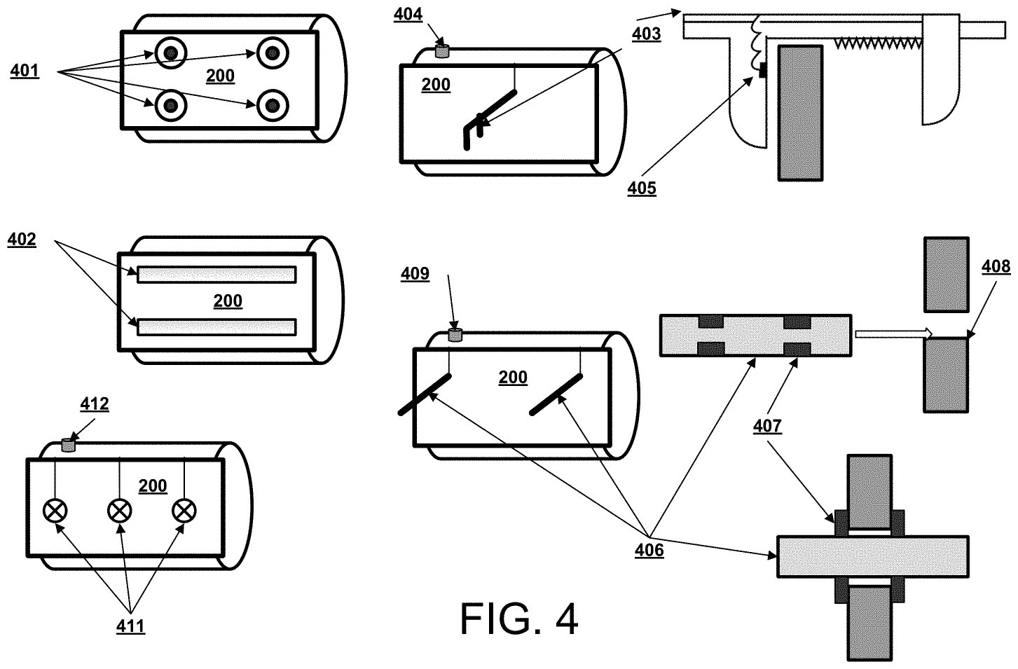

In order to facilitate rapid installation and uninstallation of the system 200 onto freight trailers, the system 200 may additionally comprise a variety of mounting implements as illustrated in FIG. 4.

In one embodiment, the system 200 additionally comprises one or more magnetic mounts 401 that facilitate attachment to the surface of a trailer or a transport container. For example, a linear arrangement of neodymium or ferrite pot magnets may be used suitable to the considerable mass of the system 200. Alternatively, another number and configuration of magnetic mounts may be used.

In one embodiment, the system 200 additionally comprises one or more adhesive surfaces 402 that facilitate attachment to the surface of a trailer or a transport container.

In one embodiment, the system 200 additionally comprises one or more powered vises 403 that facilitate attachment to the surface of a trailer or a transport container. In this embodiment, the system 200 may additionally comprise a pressure sensor 405 that provides pressure signals to the computer 203 indicative of the pressure applied by the vise 403. Responsive to signals acquired from the pressure sensor 405, the computer 203 may regulate the limit of the vise retraction distance in order to avoid damaging the mount.

In one embodiment, the system 200 additionally comprises one or more cylindrical mechanical implements 406 possessing powered retractable latches or arresting devices 407 to facilitate its deployment to surfaces possessing perforated holes 408 of an appropriate shape and size. In a further embodiment, the system 200 may additionally comprise a plurality of pressure sensors 410. Responsive to signals acquired from the pressure sensors 410, the computer 203 may regulate the angle of extraction of the latches in order to avoid damaging the mount.

In one embodiment, the system 200 additionally comprises one or more heavy-duty powered vacuum suction cups 411 to facilitate its deployment to flat surfaces of the trailer or the container.

In a further embodiment, the system 200 may additionally comprise engagement and disengagement controls 404, 409, 412 for operation of powered vacuum suction cups 411, powered retractable latches or arresting devices 407 or powered vises 403 by in situ human agents.

In one embodiment, the system 200 comprises a plurality of interconnectable units allowing individual handling and installation. For example, the system 200 may allow use of a plurality of air tanks 200 in conjunction with one computer unit 203 if it is determined that the maximum compressed air supply provided by a single tank 216 is not sufficient for the necessary number of brake disengagements according to the procedures adopted at a container yard 100, and using a larger tank 216 would violate occupational safety guidelines or operation protocols.

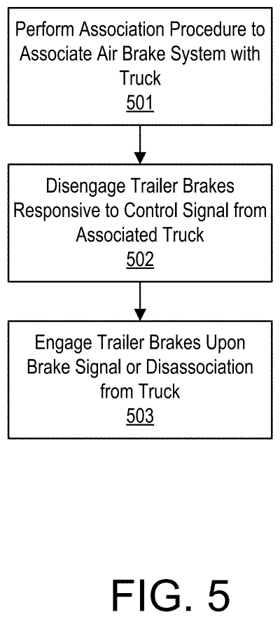

An example workflow involving the proposed device is described in FIG. 5. A shack or storage unit is located next to the entry gate 103. As a tractor unit brings in a trailer, the gate personnel attach the system 200 to the front side of the trailer. The tractor unit then drives into the yard and parks the trailer as usual. However, in addition to disconnecting the airlines of the truck from the trailer, the truck driver also attaches the airlines of the system 200 to the trailer. When an unmanned yard truck 106 picks up the trailer for shifting, it locks onto the king-pin as usual. Once locked on, the truck-trailer system performs 501 an association procedure. The computer onboard the truck 106 sends a command to the computer 203 onboard the system 200 instructing it to open the tank valve 207 and to release compressed air into the pneumatic system to disengage 502 the trailer brakes. A truck 106 then moves the trailer from the inbound staging area to the dock door. The tank 216 maintains the airline pressure until braking conditions described above are satisfied or the truck-trailer system performs a dissociation procedure, at which point it releases the air from the pneumatic system into the atmosphere, and the trailer brakes become engaged 503 again. Typical operations utilizing the above-described process include a trailer being moved from an inbound staging lot to an unloading dock, from the unloading dock to an empty staging lot, from the empty staging lot to a loading dock, or from the loading dock to an outbound staging lot. After a trailer has completed its cycle within a yard 100, a carrier truck 101 is assigned to transport it to its next destination. As the carrier truck 101 leaves the yard, the gatehouse personnel retrieve the system 200 and place it back into inventory for recharging and reuse. In case a yard operation also includes hub-to-hub transportation, both hubs may support the use of the air brake system 200, allowing additional real-time tracking benefits to be gained.

To correctly perform trailer and truck association/dissociation procedures, the truck 106 may identify the exact unit of the system 200 installed on a trailer available for pickup.

In an embodiment, the system 200 additionally comprises a barcode, a QR code, or an otherwise visual machine-readable code printed on its surface to enable its identification by a truck's 106 onboard computer or other elements of the container yard 100 information system using cameras and computer vision programs.

In another embodiment, the system 200 additionally comprises an RFID tag or a similar device or a plurality thereof to enable its identification by a truck's 106 onboard computer or other elements of the container yard 100 information system using appropriate wireless communication devices.

In a further embodiment, a truck 106 may use geopositioning information produced by the system 200 as a primary or auxiliary source data to perform system 200 identification.

In a further embodiment, the system 200 may additionally comprise an electric compressor (for example, powered by solar batteries or another energy source) to gradually recharge the air tank while the system 200 is mounted on a trailer. Such an embodiment may complement dedicated charging stations.

As containerized freight transportation is not a new technology by any measure, it may be envisaged that multiple aging container trailers are currently in operation; subsequently, performance of components such as drum brakes or spring chambers may be at end-of-life levels, and they may not properly respond to changes in airline pressure. Therefore, it is necessary to detect such situations and establish a protocol for handling them.

In an embodiment, the computer 203 may be programmed to interact with the associated truck's 106 computer and to determine whether the trailer's air brake is engaged against the currently expected disengaged state using available information on variables such the acceleration force currently applied by the truck, the mass of the truck-trailer system and the resistance expected to be offered by the trailer. If no solutions to the equations describing the system's dynamics with an acceptable degree of accuracy can be found, the computer 203 may interpret it as evidence that the trailer brakes have failed to disengage.

In an embodiment, the computer 203 may be programmed to increase pressure in the pneumatic system of the trailer beyond the levels recommended by guidelines and up to levels allowed by the appropriate industry standards singularly, gradually or in a pulsatile manner in an attempt to overcome the mechanical factors hindering normal function of the brake and to force brake disengagement. In case this protocol is followed and brake disengagement does not occur, the computer 203 may transmit an error information packet to the truck 106 computer, remote servers 214 or other recipients for further processing (such as indication of the failure on the teleoperator's HUD, demonstration of an error message on an onboard display, or assignment of an on-site human agent to investigate or to repair the problem).

In a further embodiment, the system 200 may also collect monitoring information from pressure transducers 202, 211 to detect issues arising in the pneumatic system. The computer 203 may store, analyze or transmit this information to unmanned trucks 106 present in the yard, remote servers 214, container yard 100 information system or other recipients. For example, this information may be used to detect a fault in an airline or the air tank and to estimate the time remaining until the brakes will be engaged due to the leak and the subsequent unmitigated pressure decline, and to display the countdown timer or a colored gauge indicating the health of the pneumatic system to the teleoperator.

Reference in the specification to “one embodiment” or to “an embodiment” means that a particular feature, structure, or characteristic described in connection with the embodiments is included in at least one embodiment. The appearances of the phrase “in one embodiment” or “an embodiment” in various places in the specification are not necessarily all referring to the same embodiment.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps (instructions) leading to a desired result. The steps are those requiring physical manipulations of physical quantities. Usually, though not necessarily, these quantities take the form of electrical, magnetic or optical signals capable of being stored, transferred, combined, compared and otherwise manipulated. It is convenient at times, principally for reasons of common usage, to refer to these signals as bits, values, elements, symbols, characters, terms, numbers, or the like. Furthermore, it is also convenient at times, to refer to certain arrangements of steps requiring physical manipulations or transformation of physical quantities or representations of physical quantities as modules or code devices, without loss of generality.

However, all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “determining” or the like, refer to the action and processes of a computer system, or similar electronic computing device (such as a specific computing machine), that manipulates and transforms data represented as physical (electronic) quantities within the computer system memories or registers or other such information storage, transmission or display devices.

Certain aspects of the embodiments include process steps and instructions described herein in the form of an algorithm. It should be noted that the process steps and instructions of the embodiments can be embodied in software, firmware or hardware, and when embodied in software, could be downloaded to reside on and be operated from different platforms used by a variety of operating systems. The embodiments can also be in a computer program product which can be executed on a computing system.

The embodiments also relate to an apparatus for performing the operations herein. This apparatus may be specially constructed for the purposes, e.g., a specific computer, or it may comprise a computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Memory can include any of the above and/or other devices that can store information/data/programs and can be transient or non-transient medium, where a non-transient or non-transitory medium can include memory/storage that stores information for more than a minimal duration. Furthermore, the computers referred to in the specification may include a single processor or may be architectures employing multiple processor designs for increased computing capability.

The algorithms and displays presented herein are not inherently related to any particular computer or other apparatus. Various systems may also be used with programs in accordance with the teachings herein, or it may prove convenient to construct more specialized apparatus to perform the method steps. The structure for a variety of these systems will appear from the description herein. In addition, the embodiments are not described with reference to any particular programming language. It will be appreciated that a variety of programming languages may be used to implement the teachings of the embodiments as described herein, and any references herein to specific languages are provided for disclosure of enablement and best mode.

Throughout this specification, some embodiments have used the expression “coupled” along with its derivatives. The term “coupled” as used herein is not necessarily limited to two or more elements being in direct physical or electrical contact. Rather, the term “coupled” may also encompass two or more elements are not in direct contact with each other, but yet still co-operate or interact with each other, or are structured to provide a thermal conduction path between the elements.

Likewise, as used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

In addition, the use of the “a” or “an” are employed to describe elements and components of the embodiments herein. This is done merely for convenience and to give a general sense of embodiments. This description should be read to include one or at least one and the singular also includes the plural unless it is obvious that it is meant otherwise. The use of the term and/or is intended to mean any of: “both”, “and”, or “or.”

In addition, the language used in the specification has been principally selected for readability and instructional purposes, and may not have been selected to delineate or circumscribe the inventive subject matter. Accordingly, the disclosure of the embodiments is intended to be illustrative, but not limiting, of the scope of the embodiments.

While particular embodiments and applications have been illustrated and described herein, it is to be understood that the embodiments are not limited to the precise construction and components disclosed herein and that various modifications, changes, and variations may be made in the arrangement, operation, and details of the methods and apparatuses of the embodiments without departing from the spirit and scope of the embodiments.

1. An air brake controller system for a vehicle trailer associated with a vehicle, comprising:
a wireless communication device to wirelessly receive brake control signals;
an on-board computer to process the brake control signals to generate one or more valve control signals;
a compressed air reservoir for storing compressed air;
a valve for controlling flow of air from the compressed air reservoir to one or more air lines in response to the valve control signals.

2. The air brake controller system of claim 1, wherein the one or more air lines comprises:
a first air brake connector to connect to a service line of the vehicle trailer;
a first flexible hose coupled between the valve and the first air brake connector;
a first pressure transducer to sense a first pressure of the first flexible hose and to communicate the first pressure to the on-board computer;
a second air brake connector to connect to an emergency line of the vehicle trailer;
a second flexible hose coupled between the valve and the second air brake connector;
a second pressure transducer to sense a second pressure of the first flexible hose and to communicate the second pressure to the on-board computer.

3. The air brake controller system of claim 1, further comprising:
a pressure transducer to sense a pressure of the compressed air reservoir and communicate the sensed pressure to the on-board computer.

4. The air brake controller system of claim 1, wherein the wireless communication device is configured to wirelessly receive the brake control signals from a remote support server providing teleoperation control signals to the vehicle including the brake control signals.

5. The air brake controller system of claim 1, wherein the wireless communication device is configured to wirelessly receive the brake control signals from a truck that is electronically paired with the air brake controller.

6. The air brake controller system of claim 1, wherein the on-board computer comprises:
a processor; and
a non-transitory computer-readable storage medium storing instructions that when executed by the processor cause the processor to perform steps including:
recording timestamps of brake control packets received by the wireless communication device;
determining if a current time is at least a threshold time period beyond a last recorded timestamp of a most recent brake control packet; and
responsive to determining that the current time is at least the threshold time period beyond the last recorded timestamp, generating a valve control signal to cause the valve to release pressure in the one or more air lines.

7. The air brake controller system of claim 1, wherein the on-board computer comprises:
a processor; and
a non-transitory computer-readable storage medium storing instructions that when executed by the processor cause the processor to perform steps including:
receiving one or more emergency brake packets from the wireless communication device;
responsive to receiving the one or more emergency brake packets, generating a valve control signal to cause the valve to release pressure in the one or more air lines.

8. The air brake controller system of claim 1, further comprising:
a connectivity sensor to detect a connection between the air lines of the air brake controller and the trailer and to report a connectivity state to the on-board computer representing a state of the connection.

9. The air brake controller system of claim 1, further comprising:
a mounting device for detachably mounting the air brake controller to the vehicle trailer.

10. The air brake controller system of claim 1, further comprising:
a positioning system to determine a position of the air brake controller system; and
wherein the on-board computer reports the position to a remote support server to enable location of the air brake controller system.

11. The air brake controller system of claim 1, wherein the on-board computer comprises:
a processor; and
a non-transitory computer-readable storage medium storing instructions that when executed by the processor cause the processor to perform steps including:
transmitting pressure control signals to gradually increase pressure in the one or more air lines in response to detecting mechanical error;
detecting if brake disengagement occurs; and
responsive to brake disengagement failing to occur, transmitting error information to the vehicle or a remote support server.

12. The air brake controller system of claim 1, wherein the on-board computer comprises:
a processor; and
a non-transitory computer-readable storage medium storing instructions that when executed by the processor cause the processor to perform steps including:
monitoring pressure data from transducers sensing pressuring the one or more airlines;
detecting a pneumatic fault based on the sensed pressure data; and
transmitting an error signal indicative of the pneumatic fault to the vehicle or a remote support server.

13. A method for operating an air brake controller system for a vehicle trailer associated with a vehicle, the method comprising:
storing compressed air in a compressed air reservoir;
wirelessly receiving brake control signals by a wireless communication device;
processing the brake control signals to generate one or more valve control signals; and
operating a valve to control flow of air from the compressed air reservoir to one or more air lines in response to the valve control signals.

14. The method of claim 13, further comprising:
recording timestamps of brake control packets received by the wireless communication device;
determining if a current time is at least a threshold time period beyond a last recorded timestamp of a most recent brake control packet; and
responsive to determining that the current time is at least the threshold time period beyond the last recorded timestamp, generating a valve control signal to cause the valve to release pressure in the one or more air lines.

15. The method of claim 13, further comprising:
receiving one or more emergency brake packets from the wireless communication device;
responsive to receiving the one or more emergency brake packets, generating a valve control signal to cause the valve to release pressure in the one or more air lines.

16. The method of claim 13, further comprising:
transmitting pressure control signals to gradually increase pressure in the one or more air lines in response to detecting mechanical error;
detecting if brake disengagement occurs; and
responsive to brake disengagement failing to occur, transmitting error information to the vehicle or a remote support server.

17. The method of claim 13, further comprising:
monitoring pressure data from transducers sensing pressuring the one or more airlines;
detecting a pneumatic fault based on the sensed pressure data; and
transmitting an error signal indicative of the pneumatic fault to the vehicle or a remote support server.

18. A vehicle system comprising:
a vehicle a drive system enabling teleoperation control of the vehicle by a remote support server;
an air brake controller system for attaching to the vehicle or a trailer attached to the vehicle, the air brake controller system comprising:
a wireless communication device to wirelessly receive brake control signals;
an on-board computer to process the brake control signals to generate one or more valve control signals;
a compressed air reservoir for storing compressed air;
a valve for controlling flow of air from the compressed air reservoir to one or more air lines in response to the valve control signals.

19. The vehicle system of claim 18, wherein the one or more air lines comprises:
a first air brake connector to connect to a service line of the vehicle trailer;
a first flexible hose coupled between the valve and the first air brake connector;
a first pressure transducer to sense a first pressure of the first flexible hose and to communicate the first pressure to the on-board computer;
a second air brake connector to connect to an emergency line of the vehicle trailer;
a second flexible hose coupled between the valve and the second air brake connector; and
a second pressure transducer to sense a second pressure of the first flexible hose and to communicate the second pressure to the on-board computer.

20. The vehicle system of claim 18, wherein the air brake controller system further comprises a pressure transducer to sense a pressure of the compressed air reservoir and communicate the sensed pressure to the on-board computer.
